(19) United States
(12) Patent Application Publication
(10) Pub. No.: US 2022/0203922 A1
(43) Pub. Date: Jun. 30, 2022

(54) OCCUPANT PROTECTION SYSTEM AND VEHICLE SEAT EQUIPPED WITH THE SAME

(71) Applicant: DAICEL CORPORATION, Osaka-shi, Osaka (JP)

(72) Inventor: Masayuki YAMAZAKI, Tokyo (JP)

(73) Assignee: DAICEL CORPORATION, Osaka-shi, Osaka (JP)

(21) Appl. No.: 17/606,244

(22) PCT Filed: Apr. 8, 2020
(86) PCT No.: PCT/JP2020/015866

§ 371 Date: Oct. 25, 2021

(30) Foreign Application Priority Data
Apr. 26, 2019 (JP) 2019-086675

(51) Int. Cl. B60R 21/207; B60R 21/015; B60R 21/0132; B60R 21/264; B60R 21/233; B60R 22/46; B60R 22/26; B60R 21/261

(52) U.S. Cl. CPC B60R 21/207; B60R 21/01554; B60R 21/01516; B60R 21/0132; B60R 2021/2615; B60R 21/233; B60R 22/4628; B60R 22/26; B60R 21/261; B60R 21/264

(57) ABSTRACT

An occupant protection system for a vehicle seat on which an occupant sits, the occupant protection system including: an acquiring unit that acquires information of at least one of a state of the vehicle seat, a state of the occupant seated on the vehicle seat, a traveling state of the vehicle, or an environment state of a periphery of the vehicle; a plurality of airbags disposed in correspondence with each portion of the occupant and inflated by supply of gas; a gas generator that generates the gas to be supplied to the airbags; and a control unit that, based on the information acquired by the acquiring unit, selects airbag out of the plurality of airbags, necessary to suppress the occupant from moving in an acting direction of inertial force from the vehicle seat, and that controls a supply amount of the gas to each airbag such that the selected airbag inflates.

### FIELD

The present disclosure relates to an occupant protection system for a vehicle seat arranged in a vehicle.

### BACKGROUND

Techniques for protecting the occupant of a vehicle are known. For example, Patent Document 1 describes a vehicle safety seat including a plurality of airbags stored in a seat, a gas generator, a sensor that detects a state of a vehicle, and a control circuit that controls the driving of the gas generator. In this vehicle safety seat, the control circuit drives the gas generator when a signal generated by the sensor exceeds a predetermined threshold value to supply gas to the airbag by the gas generator.

### CITATION LIST

### Patent Document

[Patent Document 1] US 2016/0082915 A

### SUMMARY

### Technical Problem

The volume of the gas required to inflate all of the plurality of airbags stored in the vehicle seat increases, resulting in a need to increase the gas generator, which may lead to a decrease in the degree of freedom of the seat design. If gas of an amount required to inflate the airbag cannot be supplied, the airbag cannot be appropriately inflated, leading to a problem that the occupant cannot be protected.

In recent years, automatic driving of vehicles has progressed. In a vehicle performing automatic driving, a case where the vehicle seat is rotated from the forward direction relative to the vehicle is assumed, and the airbag that needs to be inflated to protect the occupant differs depending on the orientation of the vehicle seat with respect to the advancing direction of the vehicle. Thus, to protect an occupant seated on the vehicle seat when the vehicle seat is used in various orientations, a large number of airbags need to be installed in the vehicle seat. Furthermore, when deploying a large number of airbags, a large amount of gas is required, and hence the gas generator that supplies the gas must be increased, and the entire device configuration becomes bulky. On the other hand, when the airbag that needs to be inflated to protect the occupant cannot be inflated, there is a problem that the occupant cannot be protected.

The present disclosure has been conceived in view of the circumstances described above, and an object thereof is to provide an occupant protection system capable of protecting an occupant.

### Solution to Problem

To solve the above problems, the occupant protection system of the present disclosure has adopted a configuration that an airbag necessary to suppress the occupant from moving in the acting direction of the inertial force is selected, and that the supply amount of gas to each airbag is controlled such that the selected airbag inflates. Such a configuration allows the occupant protection system to protect the occupant because necessary airbags can be inflated to protect the occupant.

Specifically, the present disclosure relates to an occupant protection system for a vehicle seat on which an occupant of a vehicle sits, the occupant protection system including an acquiring unit that acquires information of at least one of a state of the vehicle seat, a state of the occupant seated on the vehicle seat, a traveling state of the vehicle, or an environment state of a periphery of the vehicle; a plurality of airbags disposed in correspondence with each portion of the occupant and inflated by supply of gas; a gas generator that generates gas to be supplied to the airbags; and a control unit that, based on the information acquired by the acquiring unit, selects an airbag out of the plurality of airbags, necessary to suppress the occupant from moving in an acting direction of inertial force from the vehicle seat, and that controls a supply amount of gas to each airbag such that the selected airbag inflates.

In the occupant protection system described above, the control unit selects the airbag necessary to protect the occupant by suppressing movement of the occupant in the acting direction of the inertial force based on the information of at least one of the state of the vehicle seat, the state of the occupant seated on the vehicle seat, the traveling state of the vehicle, or the environment state of the periphery of the vehicle. The vehicle seat may take a variety of orientations, but the direction in which the inertial force acts when subjected to an impact is the advancing direction. Thus, the present disclosure determines an airbag to be inflated from a plurality of airbags and supplies gas thereto. That is, since the vehicle seat described above can preferentially inflate the airbag necessary to protect the occupant, all of the airbags do not need to be inflated. As a result, the required amount of gas is reduced, and the occupant can be protected from an impact such as an accident while reducing the size of the configuration related to the occupant protection system.

Further, in the occupant protection system described above, the gas generator and each of the plurality of airbags may be connected to enable the gas generated by the gas generator to be shared by the plurality of airbags, a plurality of valves may be further provided in correspondence with each of the airbags to independently adjust the supply amount of the gas to each airbag, and the control unit may control each degree of opening of the plurality of valves such that the gas is supplied to the selected airbag. The location to arrange these valves is not particularly limited as long as the supply amount of gas to each airbag can be controlled independently. Thus, each valve merely needs to be arranged at least in the flow path until the gas supplied from the gas generator reaches the airbag. That is, in the occupant protection system, not all airbags need to be inflated, but the airbag to be inflated is not limited to one, and the airbags to be inflated may be multiple.

Further, in the occupant protection system described above, the control unit may constantly control each degree of opening of the plurality of valves based on the information acquired by the acquiring unit. According to the occupant protection system having this configuration, the necessary airbag can be inflated even when a sudden collision occurs, and thus the occupant can be protected by selecting an airbag necessary to protect the occupant even in a state where a collision is not predicted to occur in the vehicle.

The occupant protection system described above may further include: a seatbelt that restrains the occupant relative to the vehicle seat; and a retractor that winds the seatbelt, where the plurality of airbags, the gas generator, the plurality of valves, the seatbelt, and the retractor may be disposed in the vehicle seat. The gas generator and the retractor may be connected to enable the gas generated by the gas generator to be shared by the plurality of airbags and the retractor. Further, the retractor may apply tension to the seatbelt by being supplied with the gas from the gas generator to pull the seatbelt. The retractor has a mechanism of pulling the seatbelt to apply tension to the seatbelt by being supplied with gas. As the retractor applies tension to the seatbelt, the restraining force to the seat of the occupant by the seatbelt is increased. According to the occupant protection system having this configuration, the occupant can be suppressed from moving in the acting direction of the inertial force from the vehicle seat at the time of collision of the vehicle with the seatbelt, thereby protecting the occupant.

Further, in the occupant protection system described above, a seat back of the vehicle seat is configured to be tiltable with respect to the seat cushion of the vehicle seat, and the acquiring unit may acquire the state of the vehicle seat from at least one sensor of a sensor that detects an orientation of the vehicle seat, a sensor that detects a tilt angle of the seat back with respect to the seat cushion, or a sensor that detects a load on the seat cushion.

Here, the “orientation of the vehicle seat” refers to the orientation of the vehicle seat with respect to a case where the front side of the vehicle seat faces the forward direction of the vehicle. In a vehicle performing automatic driving, it is assumed that the vehicle seat is used by being rotated in a front-rear direction or an opposite direction with respect to the forward direction of the vehicle, or side direction or diagonal direction with respect to the forward direction. The state of the occupant seated on the vehicle seat includes, for example, the weight, posture, and the like of the occupant. A case is also assumed where the vehicle seat is used when the tilt angle of the seat back with respect to the seat cushion is large, and is in a so-called reclining state. Since the vehicle seats described above may select the airbag necessary to protect the occupant based on information from sensors that detect these states, the necessary airbag can be preferentially inflated, and the occupant can be protected from an impact such as an accident.

Here, the present disclosure can be considered from an aspect of a vehicle seat. In other words, the present disclosure is a vehicle seat disposed on a vehicle. Specifically, a vehicle seat on which an occupant of a vehicle sits, the vehicle seat including the occupant protection system described in any of the foregoing is provided. According to the vehicle seat provided having this configuration, the occupant can be protected.

### Advantageous Effects of Invention

In accordance with techniques of the present disclosure, an occupant can be protected.

### BRIEF DESCRIPTION OF DRAWINGS

FIG. 1 is an outer appearance perspective view of a vehicle seat on which an occupant protection system according to an embodiment is mounted.

FIG. 2 is a diagram schematically illustrating a gas generator and a conduit provided in an occupant protection system according to the embodiment.

FIG. 3 is a block diagram schematically illustrating a configuration of a vehicle including a vehicle seat according to the embodiment.

FIG. 4 is a flowchart related to the processing performed by a control unit of the occupant protection system according to the embodiment.

### DESCRIPTION OF EMBODIMENTS

An occupant protection system according to an embodiment of the present disclosure will be hereinafter described with reference to the drawings. Note that each of the configurations, combinations thereof, and the like in each embodiment is an example, and various additions to the configuration, omissions, substitutions, and other changes may be made as appropriate without departing from the spirit of the present invention. The present invention is not limited by the embodiments and is limited only by the claims.

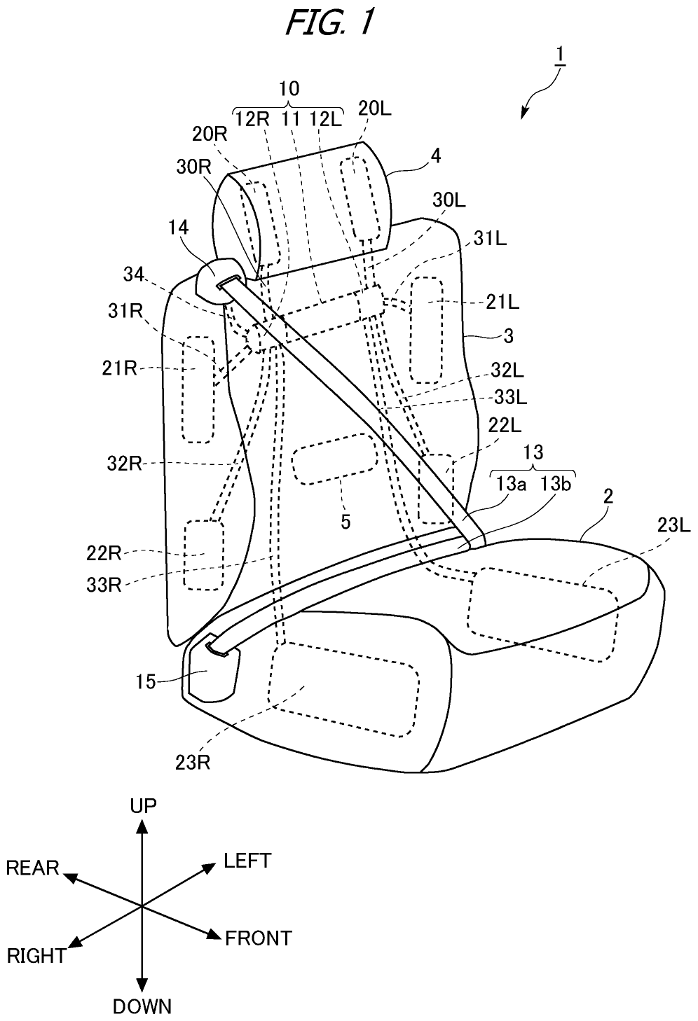

FIG. 1 is an outer appearance perspective view of a vehicle seat 1 on which an occupant protection system according to the present embodiment is mounted. Front, rear, up, down, left, and right orientations in the following description are assumed as front, rear, up, down left and right orientations in the vehicle seat 1 unless particularly stated. The arrow in FIG. 1 represents the front, rear, up, down, left, and right orientations of the vehicle seat 1.

The vehicle seat 1 is a seat on which an occupant of the vehicle sits. The vehicle seat 1 includes a seat cushion 2 having a seat surface on which an occupant sits, a seat back 3 that supports a back of the occupant and is tiltable with respect to the seat cushion 2, and a headrest 4 that is attached to the seat back 3 and supports the head of the occupant. Note that the headrest 4 may be integrally formed with the seat back 3, may be fixed to the seat back 3, or may be detachable from the seat back 3.

The occupant protection system according to the present embodiment includes a plurality of airbags that are disposed in correspondence with each portion of the occupant and inflate by supply of gas. Specifically, an occupant protection system according to the present embodiment includes: head airbags 20L, 20R disposed to correspond to the head of an occupant, chest airbags 21L, 21R disposed to correspond to the chest of the occupant, waist airbags 22L, 22R disposed to correspond to the waist of the occupant, and knee airbags 23L, 23R disposed to correspond to the knees of the occupant. The head airbags 20L, 20R are stored in the headrest 4. The chest airbags 21L, 21R and the waist airbags 22L, 22R are stored in the seat back 3. The knee airbags 23L, 23R are stored in the seat cushion 2.

The occupant protection system according to the present embodiment also includes a gas generator 10 that generates gas to be supplied to the airbag. The gas generator 10 is stored, for example, in the seat back 3. Note that the gas generator 10 may be stored in the seat cushion 2 or the headrest 4, or may be fixed to the back side of the seat surface of the seat cushion 2.

The gas generator 10 includes a metal bottle 11 having a cylindrical shape and metal diffusers 12L and 12R fixed to both ends of the bottle 11. The gas generator 10 is disposed in the seat back 3 of the vehicle seat 1 such that the diffuser 12L is located on the left side of the vehicle seat 1 and the diffuser 12R is located on the right side of the vehicle seat 1.

The gas generator 10 includes an igniter (not illustrated) and a gas generating agent that is filled into a combustion chamber formed in the bottle 11 and is combusted by the igniter. The gas generator 10 generates gas by combusting the gas generating agent. The occupant protection system according to the present embodiment inflates each airbag by supplying gas generated by the gas generator 10 to each airbag. Note that the gas generator 10 may be a hybrid type in which compressed air and a gas generating agent are enclosed in the bottle 11 to supply compressed gas and combustion gas; or a stored type formed from only compressed gas.

The diffuser 12L and 12R of the gas generator 10 and each airbag are connected, for example, by a conduit made of aluminum. Specifically, the diffuser 12L and the head airbag 20L are connected by a conduit 30L, the diffuser 12L and the chest airbag 21L are connected by a conduit 31L, the diffuser 12L and the waist airbag 22L are connected by a conduit 32L, and the diffuser 12L and the knee airbag 23L are connected by a conduit 33L. Similarly, the diffuser 12R and the head airbag 20R are connected by a conduit 30R, the diffuser 12R and the chest airbag 21R are connected by a conduit 31R, the diffuser 12R and the waist airbag 22L are connected by a conduit 32R, and the diffuser 12R and the knee airbag 23R are connected by a conduit 33L. One end of these conduits is fixed to the gas discharge ports formed in the diffusers 12L and 12R by welding or the like, and the other end of each of the conduits is connected to each airbag. Thus, in the occupant protection system according to the present embodiment, the gas generator 10 and each of the plurality of airbags are connected to enable the gas generated by the gas generator 10 to be shared by the plurality of airbags.

The occupant protection system according to the present embodiment also includes a seatbelt 13 that restricts the occupant with respect to the vehicle seat 1. The seatbelt 13 has: a shoulder belt 13a that extends from the right shoulder to the left side of the occupant to restrain the upper body of the occupant; and a lap belt 13b that extends from the lower left abdomen to the lower right abdomen of the occupant to restrain the lower abdomen of the occupant. The occupant protection system according to the present embodiment also includes a retractor 14 secured to the upper right portion of the seat back 3. The retractor 14 winds and houses the seatbelt 13 when the seatbelt 13 is not in use. Furthermore, the occupant protection system according to the present embodiment includes a fixed portion 15 that is fixed to the right side part of the seat cushion 2 and fixes a terminal end of the lap belt 13b with respect to the vehicle seat 1; an anchor portion (not illustrated) slidably attached to the seatbelt 13; and a buckle portion fixed to the left side part of the vehicle seat 1 to fix the anchor portion. When the seatbelt 13 is in use, the anchor portion is fixed to the buckle portion. Note that the upper right side with respect to the anchor portion is the shoulder belt 13a, and the right side with respect to the anchor portion is the lap belt 13b.

Additionally, the gas generator 10 and the retractor 14 are connected to enable the gas supplied by the gas generator 10 to be shared by the plurality of airbags and the retractor 14. Specifically, the diffuser 12R of the gas generator 10 and the retractor 14 are connected by a conduit 34. One end of the conduit 34 is fixed to a gas discharge port formed in the diffuser 12R by welding or the like, and the other end of the conduit 34 is connected to the retractor 14. The retractor 14 applies tension to the shoulder belt 13a by pulling the shoulder belt 13a of the seatbelt 13 by a predetermined length by providing gas from the gas generator 10, and more firmly restrains the occupant with respect to the vehicle seat 1. A known retractor can be used for the retractor 14. For example, the retractor 14 drives the piston by the supply of gas, and the piston pulls the shoulder belt 13a toward the upper right side to apply tension to the shoulder belt 13a thus applying tension to the shoulder belt 13a.

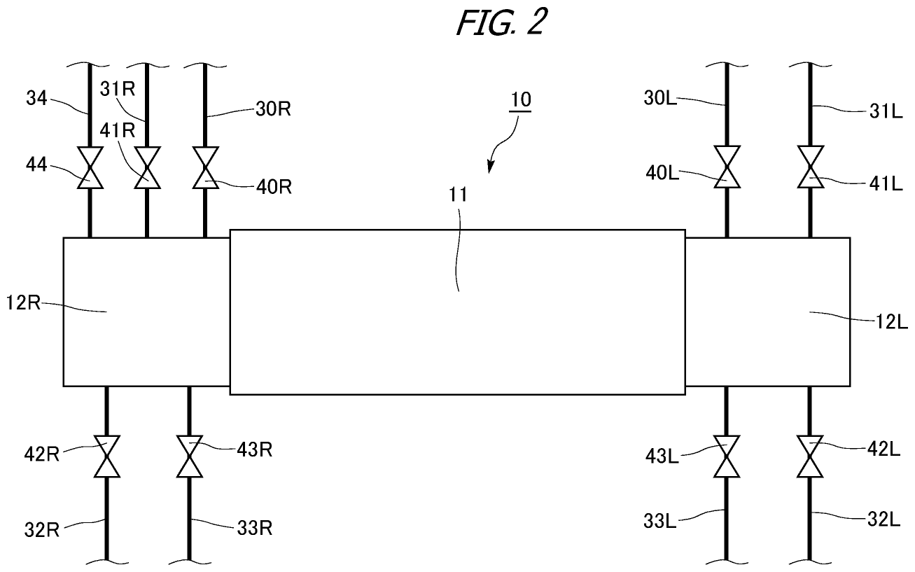

FIG. 2 is a diagram schematically illustrating the gas generator 10 and a conduit connecting the gas generator 10 and each airbag. The occupant protection system according to the present embodiment includes a plurality of valves that are provided in correspondence with each airbag and that can independently adjust the supply amount of gas to each airbag. Specifically, the occupant protection system includes a valve 40L that is disposed in the conduit 30L and can adjust a supply amount of gas to the head airbag 20L, a valve 41L that is disposed in the conduit 31L and can adjust the supply amount of gas to the chest airbag 21L, a valve 42L that is disposed in the conduit 32L and can adjust a supply amount of gas to the waist airbag 22L, and a valve 43L that is disposed in the conduit 33L and can adjust the supply amount of gas to the knee airbag 23L. Similarly, the occupant protection system includes a valve 40R that is disposed in the conduit 30R and can adjust a supply amount of gas to the head airbag 20R, a valve 41R that is disposed in the conduit 31R and can adjust the supply amount of gas to the chest airbag 21L, a valve 42R that is disposed in the conduit 32R and can adjust a supply amount of gas to the waist airbag 22R, and a valve 43R that is disposed in the conduit 33R and can adjust the supply amount of gas to the knee airbag 23R. Further, the vehicle seat 1 includes a valve 44 that is disposed in the conduit 34 and can adjust the supply amount of gas to the retractor 14. An electromagnetic valve or a motor, for example, is used as the driving means for these valves. Note that the valves merely need to be able to independently control the supply amount of gas to each airbag and the retractor 14, and may be disposed at a connecting portion between the diffusers 12L, 12R and each conduit.

The gas generated by the gas generator 10 is once moved into the diffusers 12L, 12R and is fed from the diffusers 12L, 12R to each airbag and the retractor 14 through each conduit. Thus, in the occupant protection system according to the present embodiment, the gas generated by the gas generator 10 can be shared by the plurality of airbags and the retractor 14.

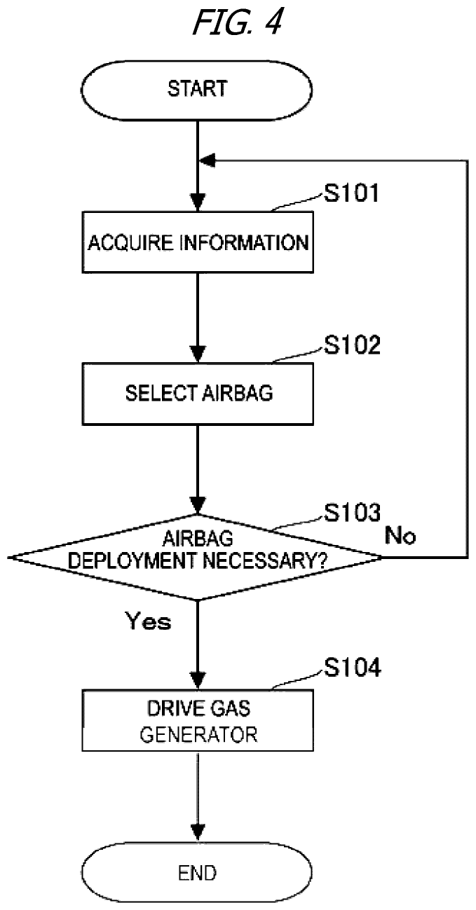

As illustrated in FIG. 1, the occupant protection system according to the present embodiment includes a control unit 5 that controls the plurality of valves described above. The control unit 5 is configured by a computer (e.g., a microcomputer) including, for example, a storage unit (ROM: Read Only Memory) (not illustrated) and a central processing unit (CPU) (not illustrated). The control unit 5 executes, for example, the process illustrated in the flowchart of FIG. 4, to be described later, by causing the CPU to execute a program stored in the storage unit. Furthermore, in the present embodiment, the control unit 5 is stored in the seat back 3. Note that the control unit 5 may be stored in the seat cushion 2 or the headrest 4, or may be fixed to the back side of the seat surface of the seat cushion 2.

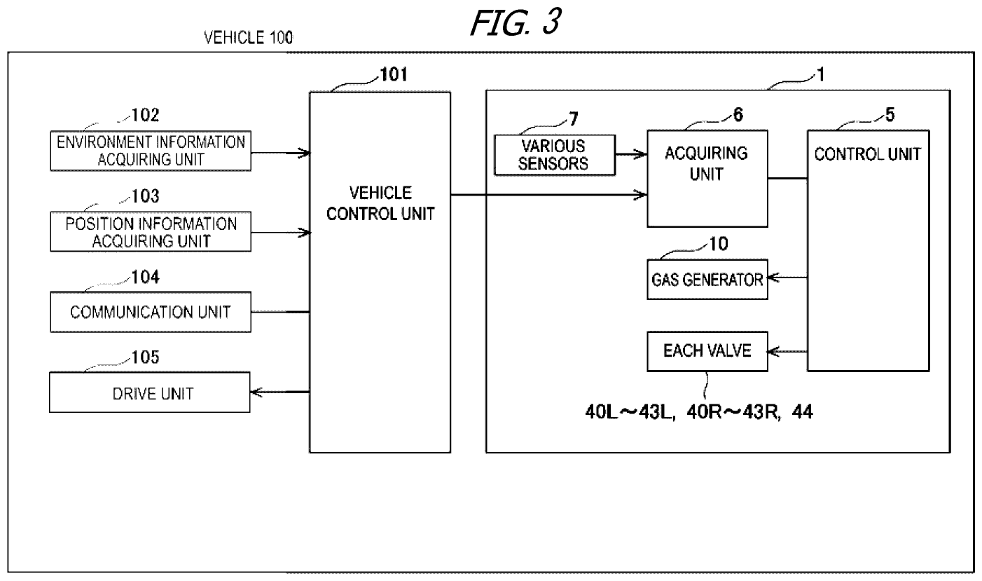

FIG. 3 is a block diagram schematically illustrating a vehicle 100 including the vehicle seat 1 on which an occupant protection system according to the present embodiment is mounted. In the present embodiment, the vehicle 100 is capable of autonomous traveling by automatic driving. The vehicle 100 includes a vehicle control unit 101 that controls the entire vehicle including control related to automatic driving, an environment information acquiring unit 102 that acquires environment information of the periphery of the vehicle 100, a position information acquiring unit 103 that acquires a current position of the vehicle 100, a communication unit 104 that communicates with an external communication device via a network, a drive unit 105 that causes the vehicle to travel, and the vehicle seat 1. Note that a plurality of the vehicle seats 1 may be installed on the vehicle 100.

The environment information acquiring unit 102 acquires the information of the periphery necessary for autonomous traveling of the vehicle 100. The environment information acquiring unit 102 is configured to include, for example, a stereo camera, radar, visible light camera, laser scanner, LIDAR, and the like. The stereo camera or radar may function as a collision prediction sensor, such as a pre-crush sensor that predicts the collision of the vehicle 100. Furthermore, the environment information acquiring unit 102 can detect an advancing direction with respect to the vehicle 100 of a collision target object and the like.

The position information acquiring unit 103 acquires the current position of the vehicle 100. For example, the position information acquiring unit 103 is configured to include a GPS receiver.

The vehicle control unit 101 controls the vehicle 100 on the basis of information acquired from the environment information acquiring unit 102 and the position information acquiring unit 103. The vehicle control unit 101 is configured by, for example, a computer (e.g., a microcomputer) including a storage unit (ROM) (not illustrated) and a CPU (not illustrated). The vehicle control unit 101 executes various processes by causing the CPU to execute a program stored in the storage unit. For example, the vehicle control unit 101 detects objects necessary for autonomous traveling such as obstacles, travel lanes, road structures, road signs, and the like that are present at the periphery of the vehicle 100 on the basis of information acquired by the environment information acquiring unit, and controls the traveling and the like of the vehicle 100. Additionally, the vehicle control unit 101 uses the position information of the vehicle 100 acquired by the position information acquiring unit 103 to perform processes such as calculation of a route to the destination, and calculation of a required time to arrive at the destination.

The communication unit 104 communicates with an external communication device (e.g., a server controlling the vehicle 100 or a communication terminal owned by an individual) via a network such as 3G (3rd Generation) or Long Term Evolution (LTE).

The drive unit 105 is configured to include an engine, a motor, a brake, a steering mechanism, and the like for driving a wheel. The drive unit 105 is driven in accordance with a control command from the vehicle control unit 101 to achieve autonomous traveling of the vehicle 100.

The vehicle seat 1 includes an acquiring unit 6 having a function of acquiring the state of the vehicle 100, the vehicle seat 1, and the like. The acquiring unit 6 acquires information of the traveling state of the vehicle, such as speed, acceleration, and steering orientation from the vehicle control unit 101. Furthermore, the acquiring unit 6 acquires information such as an obstacle or the like at the periphery of the vehicle 100 acquired by the environment information acquiring unit 102 through the vehicle control unit 101. Note that the vehicle seat 1 may have a configuration in which the acquiring unit 6 acquires the information acquired by the environment information acquiring unit 102 without passing through the vehicle control unit 101. Note that the acquiring unit 6 may be part of the functional configuration of the control unit 5.

The vehicle seat 1 includes various sensors 7. The various sensors 7 detect the state of the vehicle seat 1 and the state of the occupant seated on the vehicle seat 1. The state of the vehicle seat 1 includes the orientation of the vehicle seat 1, the tilt angle of the seat back 3 with respect to the seat cushion 2, the presence or absence of seating of the occupant, and the like. Here, the orientation of the vehicle seat 1 is the orientation of the vehicle seat 1 with respect to, as a reference, a case where the front side of the vehicle seat 1 faces the forward direction of the vehicle 100. In the vehicle 100 that performs automatic driving, it is assumed that the vehicle seat 1 is used by being rotated in a front-rear direction or an opposite direction with respect to the forward direction of the vehicle 100, or side direction or diagonal direction with respect to the forward direction. Note that the vehicle seat 1 may be installed such that the front side faces the forward direction of the vehicle 100 in the initial state. The state of the occupant seated on the vehicle seat 1 includes, for example, the weight, posture, and the like of the occupant. To detect at least one of a state of the vehicle seat 1 or a state of an occupant seated on the vehicle seat 1, the various sensors 7 include at least one or more of a sensor that detects the orientation of the vehicle seat 1, a sensor that detects the tilt angle of the seat back 3 with respect to the seat cushion 2, or a sensor that detects a load applied to the seat cushion 2. Note that the various sensors 7 may include a sensor that detects a state on whether or not the seatbelt 13 is being used (a state on whether the anchor portion is fixed to the buckle portion).

Furthermore, as illustrated in FIG. 3, the control unit 5 controls the gas generator 10 and each of the bubbles 40L to 43L, 40R to 43R, and 44. More specifically, the control unit 5 independently controls the activation of the igniter of the gas generator 10 and each degree of opening of each valve. Note that the control unit 5 may control the degree of opening of each valve to either fully open or fully closed, or may control the degree of opening to any degree of opening that is discontinuous or continuous.

FIG. 4 is a flowchart illustrating a process performed by the control unit 5 of the occupant protection system according to the present embodiment. First, the control unit 5 acquires, from the acquiring unit 6, information of at least one of the state of the vehicle seat 1, the state of the occupant seated on the vehicle seat 1, the traveling state of the vehicle 100, or the environment state of the periphery of the vehicle 100 (step S101).

In the next step S102 of step S101, the control unit 5 selects an airbag that needs to be inflated to protect the occupant. Specifically, the control unit 5 selects airbag out of a plurality of airbags, necessary to suppress the occupant from moving in the acting direction of the inertial force from the vehicle seat 1 (head airbags 20L, 20R; chest airbags 21L, 21R; waist airbags 22L, 22R; knee airbags 23L, 23R), and controls the supply amount of gas to each airbag such that the selected airbag inflates. In the occupant protection system according to the present embodiment, control of the supply amount of gas supplied to each airbag is performed by the degree of opening of each valve. The control unit 5 controls each degree of opening of the plurality of valves (valves 40L to 43L, 40R to 43R) such that gas is supplied to the selected airbag. For example, in a case where the vehicle seat 1 is rotated and the vehicle seat 1 faces the left with respect to the advancing direction of the vehicle 100, when an obstacle having the possibility of colliding exists on the front side in the advancing direction of the vehicle 100, the control unit 5 selects the head airbag 20R, the chest airbag 21R, the waist airbag 22R, and the knee airbag 23R that are disposed on the right side of the vehicle seat 1, as an airbag necessary to suppress the occupant from moving in the acting direction of the inertial force from the vehicle seat 1. The occupant protection system according to the present embodiment can select the airbag required for occupant protection according to the orientation of the vehicle seat 1 and inflate the airbag, and thus can protect the occupant.

Further, the airbag to be inflated may be varied depending on the tilt angle of the seat back 3 with respect to the seat cushion 2 of the vehicle seat 1. For example, in a case where the tilt angle of the seat back 3 with respect to the seat cushion 2 is small, the control unit 5 selects the head airbags 20L, 20R, the chest airbag 21L, 21R, and the waist airbags 22L, 22R. In addition, when the tilt angle of the seat back 3 with respect to the seat cushion 2 is large and the vehicle seat 1 is used in a so-called reclining state, the control unit 5 selects the head airbags 20L, 20R, and the knee airbags 23L, 23R. Thus, the occupant protection system according to the present embodiment can preferentially inflate the airbag necessary to suppress the occupant from moving in the acting direction of the inertial force, and thus the occupant can be protected from impacts such as accidents.

Note that the control unit 5 may control the degree of opening of the valve 44 that adjusts the supply amount of gas to the retractor 14 based on the information acquired from the acquiring unit 6. For example, in a state where the seatbelt is in use, when the occupant can be suppressed from moving in the acting direction of the inertial force from the vehicle seat 1 by the seatbelt 13 at the time of collision of the vehicle 100, that is, when the acting direction of the inertial force is the forward direction of the vehicle seat 1, the control unit 5 may control the degree of opening of the valve 44 to supply gas to the retractor 14.

In the present embodiment, the control unit 5 constantly controls each degree of opening of the plurality of valves on the basis of information acquired by the acquiring unit 6. The occupant protection system according to the present embodiment can inflate the necessary airbag even at the time of occurrence of sudden collision, and thus can protect the occupant, by having selected the airbag necessary to protect the occupant even in a state where a collision is not predicted to occur in the vehicle 100. Furthermore, according to the occupant protection system of the present embodiment, since all of the airbags do not need to be inflated to protect the occupant, and the amount of gas required to protect the occupant can be reduced, the size of the gas generator 10 can be reduced, and hence the degree of freedom of the design of the vehicle seat 1 can be increased.

In the next step S103 of step S102, the control unit 5 determines whether or not inflation of the airbag is necessary in the vehicle 100. For example, the control unit 5 determines whether a collision that requires inflation of the airbag in the vehicle 100 is expected to occur. For example, in a case where the vehicle control unit 100 determines that the vehicle 100 collides or has a very high possibility of colliding, from the information acquired by the environment information acquiring unit 102, the control unit 5 determines that inflation of the airbag is necessary. Note that the control unit 5 may perform the preliminary determination of the collision of the vehicle 100.

Furthermore, the process in step S103 is not limited to the above. The control unit 5 may determine whether or not to inflate the airbag based on at least one or more of a state of the vehicle seat 1, a state of the occupant seated on the vehicle seat 1, a traveling state of the vehicle 100, or an environment state of the periphery of the vehicle 100. For example, the control unit 5 may determine that inflation of the airbag is not necessary when determining that the occupant is not seated on the vehicle seat 1 based on information from the sensor that detects load applied to the seat cushion 2, the sensor included in the various sensors 7. Furthermore, when a collision occurs at the vehicle 100 or when determining that the possibility of collision is extremely high at a stage before the collision, and when determining that the inertial force applied to the occupant is greater than or equal to a predetermined value, based on the weight of the occupant seated on the vehicle seat 1, the speed of the vehicle 100, and the relative speed with respect to the vehicle 100 of the collision target object, the control unit 5 may determine that inflation of the airbag is necessary. According to the occupant protection system of the present embodiment, the airbag necessary to protect the occupant can be selected before the collision of the vehicle 100, and the necessary airbag can beinflated immediately before the collision, and thus an event in which the occupant cannot be protected if the airbag is inflated after the collision can be prevented, and the occupant is suppressed from moving in the acting direction of inertial force, thus protecting the occupant.

Next, when the control unit 5 determines that it is a collision that requires inflation of the airbag in step S103 (Yes in step S103), the process of step S104 is executed. In step S104, the control unit 5 drives the gas generator 5 by activating the igniter of the gas generator 5, and supplies the generated gas to the necessary airbag. Thus, according to the occupant protection system of the present embodiment, gas is supplied to the airbag or the retractor 14 necessary to protect the occupant and inflates the airbag; or the retractor 14 pulls the seatbelt 13 to apply tension to the seatbelt, thus suppressing the occupant from moving in the acting direction of the inertial force and protecting the occupant.

On the other hand, when determining that inflation of the airbag is not necessary by the control unit 5 in step S103 (No in step S103), the process returns to step S101.

As described above, the occupant protection system according to the present embodiment includes: the acquiring unit 6 that acquires information of at least one of a state of the vehicle seat 1, a state of the occupant seated on the vehicle seat 1, a traveling state of the vehicle 100, or an environment state of the periphery of the vehicle 100; and a control unit 5 that, based on the information acquired by the acquiring unit 6, selects airbag out of a plurality of airbags, necessary to suppress the occupant from moving in the acting direction of the inertial force from the vehicle seat 1, and that controls the supply amount of gas to each airbag such that the selected airbag inflates. According to the occupant protection system of the present embodiment, the occupant can be protected.

Note that the configuration of the occupant protection system is not limited to the embodiments described above. In the vehicle seat 1 according to the embodiment described above, each airbag that protects the head and the chest are disposed on the left and the right, but as disclosed in JP 2019-18593 A, JP 2019-18791 A, JP 6475150 and the like, one airbag for protecting the head and one airbag for protecting the chest may be provided.

In addition, the plurality of airbags may be connected and integrated, the interior of one airbag may be configured in sections corresponding to the head, shoulder, chest, waist, and knee, and the control unit 5 may select a section in which inflation is necessary to suppress the occupant from moving in the acting direction of the inertial force. With such a configuration as well, the entire airbag does not need to be inflated, and hence the amount of gas required to protect the occupant can be reduced, the size of the gas generator 10 can be reduced, and thus the degree of freedom of the design of the vehicle seat 1 can be increased. Furthermore, in the occupant protection system, the number of gas generators 10 is not limited. A total of two gas generators, the gas generator for each airbag (the head airbag 20R, the chest airbag 21R, the waist airbag 22R, and the knee airbag 23R) disposed on the right side of the vehicle seat 1; and the gas generator for each airbag (the head airbag 20L, the chest airbag 21L, the waist airbag 22L, and the knee airbag 23L) disposed on the left side of the vehicle seat 1 may be used. For example, as shown in FIG. 1, the retractor 14 is disposed on the right side of the vehicle seat 1, and thus the conduit 34 for the retractor 14 can be connected to the right airbag gas generator.

Each aspect disclosed in the present specification can be combined with any other feature disclosed herein.

### REFERENCE SIGNS LIST

1 Vehicle seat
2 Seat cushion
3 Seat back
4 Headrest
5 Control unit
6 Acquiring unit
7 Various sensors
10 Gas generator
11 Bottle
12L, 12R Diffuser
13 Seatbelt
14 Retractor
15 Fixed portion
20L, 20R Head airbag
21L, 21R Chest airbag
22L, 22R Waist airbag
23L, 23R Knee airbag
30L, 30R, 31L, 31R, 32L, 32R, 33L, 33R, 34 Conduit
40L, 40R, 41L, 41R, 42L, 42R, 43L, 43R, 44 Valve
100 Vehicle
101 Vehicle control unit
102 Environment information acquiring unit
103 Position information acquiring unit
104 Communication unit
105 Drive unit

1.-6. (canceled)

7. An occupant protection system for a vehicle seat on which an occupant of a vehicle sits, the occupant protection system, comprising:
an acquiring unit that acquires information of at least one of a state of the vehicle seat, a state of the occupant seated on the vehicle seat, a traveling state of the vehicle, or an environment state of a periphery of the vehicle;
a plurality of airbags disposed in correspondence with each portion of the occupant and inflated by supply of gas;
a gas generator that generates the gas to be supplied to the airbags, the gas generator and each of the plurality of airbags being connected to enable the gas generated by the gas generator to be shared by the plurality of airbags;
a plurality of valves provided in correspondence with each of the airbags, each of the plurality of valves capable of independently adjusting a supply amount of the gas to each of the airbags; and
a control unit that, based on the information acquired by the acquiring unit, selects an airbag out of the plurality of airbags, necessary to suppress the occupant from moving in an acting direction of inertial force from the vehicle seat, and that controls a supply amount of the gas to each airbag such that the selected airbag inflates, the control unit controling each degree of opening of each of the plurality of valves such that the gas is supplied to the selected airbag.

8. The occupant protection system according to claim 7, wherein the gas generator includes a bottle having a cylindrical shape and a diffuser fixed to an end of the bottle,
the diffuser and each of the plurality of airbags are connected by each of conduits, and
one end of the each of couduits is fixed to the gas discharge port formed in the diffuser and other end of each of the conduits is connected to each of the plurality of airbag.

9. The occupant protection system according to claim 7, wherein the control unit constantly controls each degree of opening of the plurality of valves based on the information acquired by the acquiring unit.

10. The occupant protection system according to claim 8, wherein the control unit constantly controls each degree of opening of the plurality of valves based on the information acquired by the acquiring unit.

11. The occupant protection system according to claim 7, further comprising:
a seatbelt that restrains the occupant relative to the vehicle seat; and
a retractor that winds the seatbelt, wherein the plurality of airbags, the gas generator, the plurality of valves, the seatbelt and the retractor are disposed in the vehicle seat,
the gas generator and the retractor are connected to enable the gas generated by the gas generator to be shared by the plurality of airbags and the retractor, and
the retractor applies tension to the seatbelt by being supplied with the gas from the gas generator to pull the seatbelt.

12. The occupant protection system according to claim 7, wherein
a seat back of the vehicle seat is configured to be tiltable with respect to a seat cushion of the vehicle seat, and
the acquiring unit acquires the state of the vehicle seat from at least one sensor of a sensor that detects an orientation of the vehicle seat, a sensor that detects a tilt angle of the seat back with respect to the seat cushion, or a sensor that detects a load on the seat cushion.

13. The occupant protection system according to claim 8, wherein
a seat back of the vehicle seat is configured to be tiltable with respect to a seat cushion of the vehicle seat, and
the acquiring unit acquires the state of the vehicle seat from at least one sensor of a sensor that detects an orientation of the vehicle seat, a sensor that detects a tilt angle of the seat back with respect to the seat cushion, or a sensor that detects a load on the seat cushion.

14. The occupant protection system according to claim 9, wherein
a seat back of the vehicle seat is configured to be tiltable with respect to a seat cushion of the vehicle seat, and
the acquiring unit acquires the state of the vehicle seat from at least one sensor of a sensor that detects an orientation of the vehicle seat, a sensor that detects a tilt angle of the seat back with respect to the seat cushion, or a sensor that detects a load on the seat cushion.

15. The occupant protection system according to claim 10, wherein
a seat back of the vehicle seat is configured to be tiltable with respect to a seat cushion of the vehicle seat, and
the acquiring unit acquires the state of the vehicle seat from at least one sensor of a sensor that detects an orientation of the vehicle seat, a sensor that detects a tilt angle of the seat back with respect to the seat cushion, or a sensor that detects a load on the seat cushion.

16. The occupant protection system according to claim 11, wherein
a seat back of the vehicle seat is configured to be tiltable with respect to a seat cushion of the vehicle seat, and
the acquiring unit acquires the state of the vehicle seat from at least one sensor of a sensor that detects an orientation of the vehicle seat, a sensor that detects a tilt angle of the seat back with respect to the seat cushion, or a sensor that detects a load on the seat cushion.

17. A vehicle seat on which an occupant of a vehicle sits, the vehicle seat comprising the occupant protection system described in claim 7.

18. A vehicle seat on which an occupant of a vehicle sits, the vehicle seat comprising the occupant protection system described in claim 8.

19. A vehicle seat on which an occupant of a vehicle sits, the vehicle seat comprising the occupant protection system described in claim 9.

20. A vehicle seat on which an occupant of a vehicle sits, the vehicle seat comprising the occupant protection system described in claim 10.

21. A vehicle seat on which an occupant of a vehicle sits, the vehicle seat comprising the occupant protection system described in claim 11.

22. A vehicle seat on which an occupant of a vehicle sits, the vehicle seat comprising the occupant protection system described in claim 12.
